(19) United States
(12) Patent Application Publication
(10) Pub. No.: US 2024/0309300 A1
(43) Pub. Date: Sep. 19, 2024

(54) Production Method for Soap Composition Containing Sodium of higher Fatty Acid and Potassium of Higher Fatty Acid

(71) Applicant: SPH CORPORATION, Saitama (JP)

(72) Inventors: Mitsuta SHIBATA, Saitama (JP); Kazuko SHIBATA, Saitama (JP); Yoshio NAKANO, Ibaraki (JP); Yasushi HAYASAKI, Saitama (JP)

(21) Appl. No.: 18/565,997

(22) PCT Filed: Dec. 9, 2022
(86) PCT No.: PCT/JP2022/045428

§ 371 Date: Nov. 30, 2023

(30) Foreign Application Priority Data
Dec. 10, 2021 (JP) 2021-201288

(51) Int. Cl. C11D 13/10; C11D 13/12; C11D 17/08

(52) U.S. Cl. CPC C11D 13/10; C11D 13/12; C11D 17/08

(57) ABSTRACT

Provided is a method for productively producing a liquid or a paste soap composition which, even at low temperatures, maintains a liquid or paste state for a long time without separating, is gentle on the skin and eyes, and has high foaming power and good cleaning power. In this production method for a soap composition containing a sodium of a higher fatty acid and a potassium of a higher fatty acid, a liquid soap composition is prepared by: heating, to at least 80° C., and melting a mixed saturated fatty acid which is composed of 12- to 18-carbon saturated fatty acids containing 85 to 100 mol % of a 12- and a 14-carbon saturated fatty acid and does not contain an 8- to 10-carbon saturated fatty acid; then adding a cooling liquid composed of glycerin and water to the mixed saturated fatty acid all at once, cooling the mixture to a temperature at least 20° C. lower than the heated temperature, and then heating the mixture again and holding the mixture at a temperature between 40 and 55° C.; adding a mixed alkaline aqueous solution all at once to the mixed fatty acid-containing liquid that has been heated and held at said temperature, said mixed alkaline aqueous solution being obtained by mixing potassium hydroxide and/or potassium carbonate and sodium hydroxide and/or sodium carbonate in a molar ratio in the range from 90/10 to 30/70; and, while agitating, heating the mixture and then holding the mixture at a temperature between 80 and 95° C. in order to neutralize the mixture.

### TECHNICAL FIELD

The present invention relates to a production method for a soap composition containing sodium of a higher fatty acid and potassium of a higher fatty acid for cleansing the skin, and in particular to a production method for a soap composition containing sodium of a higher fatty acid and potassium of a higher fatty acid that contains a higher fatty acid sodium soap with a concentration higher than that of the conventional soap composition, that can maintain a paste state or a liquid state over a longer period of time even at a lower temperature, that is good in usability with a higher foaming power and less stimulation of the skin and the eyes, and that is environmentally-friendly.

### BACKGROUND ART

Various types of technologies concerning soaps for cleansing the body, such as a hair cleansing agent, a skin cleansing agent, and a face cleanser, have already been publicly known, and a great number of products that include a chemically synthesized surfactant (hereinafter, abbreviated as “synthetic activator”), such as an alkyl sulfate, an alkyl ether sulfate, an α-olefin sulfonate, alkyl carboxy betaine, or an alkyl methyl taurine salt, have been commercially available.

Methods for producing a fatty acid soap have been put into practice for a long time, and a saponification method for heating a fat or an oil to which alkaline water has been added and a neutralization method for adding alkaline water to a fatty acid are common.

In particular, as a liquid body soap of which the main component is a fatty acid soap, a fatty acid potassium salt (hereinafter, abbreviated as “potash soap”) that can be gained by neutralizing or saponifying a fatty acid, a fat, or an oil with potassium hydroxide is widely used. Some of these liquid potassium soaps are circulated as a liquid soap that has been distilled with water to a concentration that does not congeal or coagulate.

For example, Japanese Unexamined Patent Publication 2006-206525 (Patent Literature 1) discloses a paste skin cleanser that contains (a) 25 to 50 mass % of a higher fatty acid soap, (b) 0.5 to 10 mass % of a lower alcohol, and (c) water.

In addition, Japanese Unexamined Patent Publication 2002-322498 (Patent Literature 2) has proposed as a fatty acid soap a composition that contains a certain weight ratio of a myristic acid soap, a palmitic acid soap, and a stearic acid soap, propylene glycol, glycerin, and water.

Japanese Unexamined Patent Publication 2004-210704 (Patent Literature 3) has proposed a skin cleansing agent composition that contains (A) a higher fatty acid salt, (B) an amino acid-based polymer, and (C) two or more types of water soluble polymers (excluding the component B) having different ionic properties.

Furthermore, Japanese Unexamined Patent Publication 2011-121870 (Patent Literature 4) has proposed a skin cleansing agent that contains (A) 1 to 10 mass % of an anionic surfactant having a sulfate group, (B) 1 to 25 mass % of a higher fatty acid or a salt thereof, (C) 0.1 to 2 mass % of an acrylic acid·alkyl methacrylate copolymer, (D) 0.5 to 10 mass % of a (di)glycerin monofatty acid ester or a (di)glycerin monoalkyl ether, (E) 0.5 to 10 mass % of alkyl polyglucoside, and (F) water so as to have a viscosity of 150 to 1000 dPa·s at 30° C.

Moreover, Japanese Unexamined Patent Publication 2015-196713 (Patent Literature 5) discloses a transparent liquid cleansing agent composition where the content of (A) a higher fatty acid potassium salt that has been gained through the reaction between one mol of a higher fatty acid containing 50 or more mass % of lauric acid in the fatty acid composition, and 1 to 1.01 mol of potassium hydroxide is 5 to 30 mass %, the content of (B) alkyl hydroxy sulfobetaine-type ampholytic surfactant is 1 to 10 mass %, and the mass ratio of (A):(B) is 1:0.05 to 1.

Meanwhile, sodium salt of a saturated fatty acid (hereinafter, abbreviated as “sodium soap”) is mainly used as a solid soap; however, solubility in water is significantly low as compared to potassium soap, and thus barely dissolves in water. Therefore, sodium soap is circulated as soap chips that are an industrial raw material which is heated in a kneading machine, where an additive is mixed in, and after that, the liquid of which the viscosity has been adjusted is put into a frame so as to be processed into toilet soap or the like. Soap chips of sodium soap also have a low water solubility, and it is not easy to gain a uniform solution thereof even in warm water.

Liquid soap that mainly contains potassium soap, however, does not have sufficient foaming or cleansing power, and thus, in order to improve this, at least one or more types from among a non-ionic surfactant, an anionic surfactant, or a zwitterionic surfactant that has been synthesized from a petrochemical material is mixed in for treatment before use. Furthermore, a polyalcohol such as sorbitol, glycerin, propylene glycol, butylene glycol, or a polyalkylene glycol, and a water soluble highly polymerized compound are mixed in order to adjust the foaming properties and the like of the composition.

Fatty acid soap does not have a problem with the safety for the environment in addition to the safety for the human body, and is highly evaluated for the feeling when used in such a manner that the foam can be easily washed off and make the body surface feel clean.

As described above, however, potassium soap has a weak point where the foaming or cleansing power is weaker as compared to a synthetic activator, whereas sodium soap has good foaming and cleansing powers that match the synthetic activator; however, it has a lower water solubility, which causes a problem.

As for the water solubility of sodium soap, it is necessary for the water to be approximately 40° C. or higher in order to dissolve 10 or more mass % of even a sodium soap with lauric acid of which the water solubility is relatively high from among sodium salts of a saturated fatty acid, where the Krafft point is 30° C. or higher, and the fluidity is lost even at a low concentration. Sodium soaps of palmitic acid or stearic acid with a longer carbon chain are said to have further lower water solubility (see revised Fatty Acid Chemistry, 2^{nd} Edition, edited by Jiro Hirano and Keiichi Inaba, Saiwai Shobo).

Because of this lowness of water solubility, the gained liquid soap products are separated or the clogging of the nozzle of a container into which the liquid soap is put occurs, and thus, at present, a liquid fatty acid soap composition of which the main component is sodium soap has not been commercialized.

In addition, compound potassium soap cleansing agents into which a synthetic activator has been mixed may be compensated in the weakness of the cleansing or foaming powers; however, the feeling when being used that is particular to fatty acid soap, that is to say, the goodness of the feeling of the foam being washed off, is lost, and thus, the stimulation of the skin and the feeling of the sliminess are pointed out.

Accordingly, it is desired to commercialize the product of a body cleansing agent of which the main component is a saturated fatty acid soap that generates rich and thick foaming that is mild on the skin with a good bodywash feeling and little feeling of sliminess, and can be easily rinsed off, leaving a clean feeling.

### CITATION LIST

### Patent Literature

Patent Literature 1: Japanese Unexamined Patent Publication 2006-206525
Patent Literature 2: Japanese Unexamined Patent Publication 2002-322498
Patent Literature 3: Japanese Unexamined Patent Publication 2004-210704
Patent Literature 4: Japanese Unexamined Patent Publication 2011-121870
Patent Literature 5: Japanese Unexamined Patent Publication 2015-196713

### SUMMARY OF THE INVENTION

### Problem to be Solved

An object of the present invention is to provide a method for manufacturing with high productivity a liquid or paste soap composition that contains a higher fatty acid sodium soap content with a high concentration together with a fatty acid potassium soap content, that can maintain a liquid or paste state over a long period of time even at a low temperature, where the soap composition does not separate, that has a low level of stimulation of the skin or the eyes, that is environmentally-friendly, and that has high foaming power and excellent cleansing power. Another object is to provide a method for manufacturing with high productivity a soap composition containing a higher fatty acid sodium and a higher fatty acid potassium, which is a liquid or paste soap composition that does not include a synthetic activator.

Here, in the present invention, “low temperature” means a temperature that is lower than 10° C.

### Solution to Problem

The present inventors carried out diligent research in order to solve the above-described problem, and as a result found out that it is possible to manufacture a soap composition containing a higher fatty acid sodium and a higher fatty acid potassium, with which the above-described problem can be solved by using a predetermined mixed fatty acid, in particular, a mixed fatty acid that includes a certain saturated fatty acid with a predetermined ratio without using a common synthetic activator, by cooling the mixed fatty acid with water to a certain temperature, and after that, heating and saponifying it with alkaline of sodium and potassium, and thus made the present invention.

That is to say, in accordance with the production method for a soap composition containing sodium of a higher fatty acid and potassium of a higher fatty acid according to the first aspect of the present invention, a liquid soap composition is prepared by heating to 80° C. or higher (a heated temperature) and melting a mixed saturated fatty acid, which is a mixed fatty acid made of saturated fatty acids of which the carbon numbers are 12 to 18 that include 85 through 100 mol % of saturated fatty acids of which the carbon numbers are 12 and 14, and does not include saturated fatty acids of which the carbon numbers are 8 through 10, and then cooling the mixed saturated fatty acid to a temperature that is lower than the heated temperature by at least 20° C. by adding at once a coolant made of glycerin and water, and after that, again heating the mixed saturated fatty acid to 40 through 55° C., maintaining the mixed saturated fatty acid at the temperature, adding at once a mixed alkaline solution where potassium hydroxide and/or potassium carbonate and sodium hydroxide and/or sodium carbonate are mixed together in a range of the mol ratio of 90/10 through 30/70 to the mixed fatty acid containing liquid that is maintained at the temperature, stirring the liquid so that the temperature rises to 80 to 95° C. (a raised temperature), and maintaining the liquid at the temperature for neutralization.

The production method for a soap composition containing sodium of a higher fatty acid and potassium of a higher fatty acid according to the first aspect of the present invention is preferably characterized in that the amount of the contained saturated fatty acid of which the carbon number is 12 is greater than that of the contained saturated fatty acid of which the carbon number is 14.

In accordance with the production method for a soap composition containing sodium of a higher fatty acid and potassium of a higher fatty acid according to the second aspect of the present invention,
a mixture of 100 mass units of a mixed saturated fatty acid and 3 to 23 mass units of magnesium stearate or magnesium palmitate is heated to 80° C. or higher so that the mixed saturated fatty acid melts, where the mixed saturated fatty acid is a mixed fatty acid made of saturated fatty acids of which the carbon numbers are 12 through 18, which include 80 to 90 mol % of saturated fatty acids of which the carbon numbers are 12 and 14 and that do not include a saturated fatty acid of which the carbon number is any of 8 through 10,
a coolant made of glycerin and water is then added at once to the mixture of the mixed saturated fatty acid and magnesium stearate or magnesium palmitate so that the mixture is cooled to a temperature that is lower than the heated temperature by at least 20° C., where 30 to 75 mass units of glycerin are mixed in 100 mass units of the mixed saturated fatty acid, after being cooled, the mixture is again heated to 40 through 55° C. and maintained at the temperature, and
a mixed alkaline solution where potassium hydroxide and/or potassium carbonate and sodium hydroxide and/or sodium carbonate are mixed together in a range of the mol ratio of 70/30 to 30/70 is added at once to the mixture that has been heated and maintained at the temperature, the mixture is stirred while the temperature rises to 80 to 95° C. and is maintained at the temperature for neutralization so as to prepare a paste soap composition, and before or after the neutralization, talc and sorbitol are mixed in the paste soap composition in such a manner that 3 to 13 mass units of talc and 50 to 180 mass units of sorbitol relative to 100 mass units of the mixed saturated fatty acid are included in the paste soap composition.

The production method for a soap composition containing sodium of a higher fatty acid and potassium of a higher fatty acid according to the second aspect of the present invention is preferably characterized by further comprising the mixing in of a saccharide and/or a fat or an oil.

### Advantageous Effects of the Invention

In the production method for a liquid soap composition containing sodium of a higher fatty acid and potassium of a higher fatty acid according to the present invention, a transparent liquid soap composition or paste soup composition can be effectively manufactured with high productivity, where the soap composition can be maintained in a uniform liquid state or a paste state over a long period of time, even at a low temperature, and at the same time, the gained soap composition is excellent in stability without separating over time, has little stimulation of the skin or the eyes, and is excellent in the feeling when being used with high foaming power.

In addition, the liquid soap composition or the paste soap composition that has been gained in accordance with the production method according to the present invention has a saturated fatty acid soap content as the cleansing component without including a surfactant, and therefore, has little stimulation of the skin and is environmentally friendly.

### DESCRIPTION OF EMBODIMENTS

The present invention is described in reference to the following preferred embodiments; however, the present invention is not limited to these.

The production method for a soap composition containing sodium of a higher fatty acid and potassium of a higher fatty acid according to the present invention relates to a method according to which a soap composition that can be maintained in a liquid or paste state over a long period of time even at a low temperature can be prepared, and in particular, the production method for a transparent liquid soap composition according to the first invention is a production method for a liquid soap composition, in accordance with which a liquid soap composition is prepared by heating to 80° C. or higher and melting a mixed saturated fatty acid, which is a mixed fatty acid made of saturated fatty acids of which the carbon numbers are 12 to 18 that include 85 through 100 mol % of saturated fatty acids of which the carbon numbers are 12 and 14, and does not include saturated fatty acids of which the carbon numbers are 8 through 10, and then cooling the mixed saturated fatty acid to a temperature that is lower than the heated temperature by at least 20° C. by adding at once a coolant made of glycerin and water, and after that, again heating the mixed saturated fatty acid to 40 through 55° C., maintaining the mixed saturated fatty acid at the temperature, adding at once a mixed alkaline solution where potassium hydroxide and/or potassium carbonate and sodium hydroxide and/or sodium carbonate are mixed together in a range of the mol ratio of 90/10 through 30/70 to the mixed fatty acid containing liquid that is maintained at the temperature, stirring the liquid so that the temperature rises to 80 to 95° C., and maintaining the liquid at the temperature for neutralization.

In the case of the prior art where the sodium soap content is large, a transparent soap composition that is excellent in the stability over a long period of time at a low temperature cannot be gained; however, the above-described configuration makes it possible for the gained soap composition to be transparent even in a low temperature range without separating over a long period of time, and thus, it becomes possible for the soap composition to be maintained in a stable liquid state.

In the production method according to the present invention, a chemically synthesized surfactant or a viscosity-inducing agent are not mixed.

The fatty acid used in the production method for a liquid soap composition according to the present invention is a mixed saturated fatty acid made of saturated fatty acids of which the carbon numbers are 12 to 18 that include 85 to 100 mol % of saturated fatty acids of which the carbon numbers are 12 and 14. Here, this fatty acid does not include a saturated fatty acid of which the carbon number is 8 or 10. This is because fatty acids that include a saturated fatty acid of which the carbon number is 8 or 10 are unstable in the long term as a liquid soap composition when being maintained over a long period as a liquid at a low temperature.

In the present invention, unsaturated fatty acids are not used. This is because soaps that include an unsaturated fatty acid change in the hue or generate an odor due to oxidation, and thus are not appropriate for cleansing the skin.

As the mixed fatty acid made of saturated fatty acids of which the carbon numbers are 12 to 18, preferably of which the carbon numbers are 12 to 16, that are used in the production method according to the present invention, lauric acid, myristic acid, palmitic acid, and stearic acid are preferably used, and a mixed fatty acid where a number of fatty acids are mixed is used.

It is desirable for the mixed fatty acid to be made of a plurality of saturated fatty acids from the point of view of stability over time in terms of the low degrees of a foul odor and a change in the hue.

Furthermore, the entirety of the mixed fatty acid made of these saturated fatty acids includes 85 to 100 mol %, preferably 88 to 98 mol %, of saturated fatty acids of which the carbon numbers are 12 and 14.

When the entirety of the mixed fatty acid has saturated fatty acids of which the carbon numbers are 12 and 14, that is to say, lauric acid and myristic acid, mixed in with the above-described high content, it becomes possible for the mixed fatty acid to be maintained in a transparent liquid state having excellent foaming properties in a low temperature range over a long period of time.

It is also desirable for the amount of the saturated fatty acid of which the carbon number is 12 that is mixed in to be greater than that of the saturated fatty acid of which the carbon number is 14 that is mixed in. This is because the above-described effects of the liquid soap composition can be more visible.

In the production method according to the present invention, the above-described mixed saturated fatty acid is heated to 80° C. or higher, preferably 90° C. or higher, and more preferably, 80 to 95° C. (heated temperature), while being stirred so that the mixed saturated fatty acid is melted uniformly. Preferably, it is melted while being stirred. Here, the heated temperature refers to the highest heated temperature at which the mixed saturated fatty acid is heated while being melted uniformly. The period of time during which the above-described mixed fatty acid is maintained at the heated temperature is not particularly limited as long as the mixed fatty acid is uniformly melted; however, an example is exhibited where the temperature is maintained for 20 to 60 minutes.

Next, a coolant is added at once to the colorless and transparent mixed fatty acid that has been heated and melted while being stirred so that the temperature is lowered by at least 20° C., preferably 25° C. or greater (cooled temperature), from the above-described heated temperature. For example, the mixed fatty acid is cooled to 60° C. or lower, preferably 50° C. or lower.

The mixture of the coolant and the mixed saturated fatty acid that has been cooled by adding the coolant is in such a state where small white particles have been suspended.

The amount of the coolant that is added and mixed is set so that the heated temperature of the melted mixed fatty acid that was heated to 80° C. or higher, preferably 90° C. or higher, can be cooled to 70° C. or lower, preferably 60° C. or lower, and more preferably 50° C. or lower, that is to say, to a temperature that is lower than the heated temperature by at least 20° C., preferably 25° C. or more, when the coolant is added at once, and thus, a coolant at room temperature, for example, at approximately 20° C., is added.

In addition, the coolant includes glycerin and purified water.

Relative to 100 mass units of the mixed fatty acid, for example, the amount of glycerin in the coolant is preferably 15 to 30 mass units, more preferably 15 to 22 mass units, whereas the amount of the purified water is preferably 100 to 250 mass units, more preferably 115 to 200 mass units. When the added coolant is a mixed liquid of glycerin and purified water in the above-described ratio, the mixed fatty acid can be cooled to the cooled temperature that is lower than the above-described heated temperature by at least 20° C., preferably 25° C. or greater.

Next, the mixed saturated fatty acid containing liquid at the cooled temperature is again heated to 40 to 55° C. and is maintained at this heat-controlled temperature. By providing this process, the gained liquid soap composition can maintain long-term stability (transparency and liquid state maintaining properties) at a low temperature with excellent foaming properties.

Next, mixed alkali is added at once to the mixed fatty acid containing liquid that has been maintained at the heat-controlled temperature, where the temperature rises to 80 to 95° C. and is maintained at the raised temperature while the mixture is being stirred during the neutralization, and thus, a liquid soap composition is prepared. In this manner, alkali is added to the mixed fatty acid containing liquid that is maintained at the heat-controlled temperature after being quickly cooled by mixing a coolant and being again heated, and then, the liquid is stirred while the temperature rises to 80 to 95° C. for neutralization, and thus, it becomes possible for the gained liquid soap composition to have liquid state maintaining properties over a long period of time even at a low temperature, and at the same time to maintain transparency.

The alkali that is used to gain fatty acid soap through neutralization of the mixed saturated fatty acid is a mixed alkali between potassium hydroxide and/or potassium carbonate and sodium hydroxide and/or sodium carbonate, where the mol ratio in this mixture between potassium hydroxide and/or potassium carbonate and sodium hydroxide and/or sodium carbonate is 90/10 to 30/70, preferably 80/20 to 60/40.

It is also desirable for purified water to be added to the mixed alkali in order to increase the viscosity during the neutralization reaction and to suppress the local generation of the neutralization heat.

As for the mixture of alkali, potassium hydroxide and/or potassium carbonate and sodium hydroxide and/or sodium carbonate may be mixed in advance so that mixed alkali is prepared, which is then used for neutralization, or they may not be mixed in advance, and instead may be respectively mixed in at the time of neutralization, and thus, either case may be possible.

In the case where the mol ratio of potassium hydroxide and/or potassium carbonate is higher than 90, the properties of potassium soap are more strongly exhibited and the foaming or cleansing power is not satisfactory. Meanwhile, in the case where the ratio of potassium hydroxide is lower than 30, the hardness of the gained soap becomes too high for the soap to be in a liquid form, and thus, the soap does not dissolve quickly in water at the time of use, which may lower the foaming properties.

It is also possible to prepare an alkali solution in advance (the standard is an active component concentration of 48%, for example) from the two above-described alkalis so that this solution can be used for neutralization of the mixed fatty acid, and as a result, it becomes possible to acquire a uniform solution in a short period of time.

At the time of neutralization, heat is emitted, and in the case where the temperature rises beyond the above-described raised temperature, there is a risk that the gained liquid soap composition will not be transparent, and therefore, the temperature is adjusted so that the raised temperature is in a range from 80 to 90° C. when the temperature rises.

As the examples of the fatty acid soap that has been gained by saponifying the above-described mixed fatty acid and mixed alkali, a mixed salt of potassium/sodium laureate, a mixed salt of potassium/sodium myristate, a mixed salt of potassium/sodium palmitate, and a mixed salt of potassium/sodium stearate can be cited, and a mixed salt of potassium/sodium laureate and a mixed salt of potassium/sodium myristate should always be included, and at the same time, it is desirable for two or more of the above-described mixed salts to be mixed for use from the point of view of the manufacture of a liquid soap having foaming properties, in particular, excellent foaming power.

The liquid soap composition that has been gained in accordance with the method according to the present invention includes 8 to 35 mass %, preferably 10 to 35 mass %, and more preferably 18 to 28 mass %, of the saturated fatty acid soap content. This is because such a liquid soap composition provides a more sufficient amount of foaming at the time of usage and maintains uniformity for a longer period of time.

The transparent liquid soap composition that has been gained as described above in accordance with the production method according to the present invention includes water, which consists of water for the cooling as described above, water that is included in the respective raw materials, and water that is generated through the neutralization between the saturated fatty acid and alkali, and examples where the water content is 92 to 65 mass %, preferably 82 to 72 mass %, in the liquid soap composition can be exhibited. In the case where the water content is adjusted to be in such a range, more satisfactory foaming properties can be gained at the time of use.

Here, the liquid soap composition that is gained in accordance with the production method according to the present invention can be provided as a liquid soap composition that has transparency and excellent liquid state maintaining properties over a long period of time at a low temperature when measured in accordance with the method that is stated in the below-described examples.

Here, the transparent liquid soap composition that is gained in accordance with the production method according to the present invention was assessed through small angle X-ray scattering (SAXS) in SPring-8 of RIKEN in Hyogo Prefecture. The average particle diameter of the soap micelle in the aqueous solution was 50 nm or less, which is microscopic, and thus, it has been proven that the soap solution maintains a transparent state.

If necessary, other arbitrary components can be mixed in as long as the effects of the present invention are not suppressed in addition to the above-described necessary components. For example, higher alcohols, squalane, various types of liquid or solid fatty acid esters, oil components such as olive oil, sesame oil, and other various types of refined natural oils and fats, silicone derivatives such as polyoxy ethylene alkyl-modified dimethyl silicone, natural water-soluble polymers such as pectin and alginic acid, biodegradable chelating agents such as sodium gluconate, various types of natural extracts originated from animals and plants, inorganic salts such as common salt and Glauber's salt for the adjustment of the congealing point or hardness, natural antioxidants such as d-tocopherol, natural pigments, natural aromatics, and the like, can be mixed in in such a range that the effects of the present invention are not lost.

In accordance with the production method for a soap composition containing sodium of a higher fatty acid and potassium of a higher fatty acid according to the second aspect of the present invention: a mixture of 100 mass units of a mixed saturated fatty acid and 3 to 23 mass units of magnesium stearate or magnesium palmitate is heated to 80° C. or higher so that the mixed saturated fatty acid melts, where the mixed saturated fatty acid is a mixed fatty acid made of saturated fatty acids of which the carbon numbers are 12 through 18, which include 80 to 90 mol % of saturated fatty acids of which the carbon numbers are 12 and 14 and that do not include a saturated fatty acid of which the carbon number is any of 8 through 10;
a coolant made of glycerin and water is then added at once to the mixture of the mixed saturated fatty acid and magnesium stearate or magnesium palmitate so that the mixture is cooled to a temperature that is lower than the heated temperature by at least 20° C., where 30 to 75 mass units of glycerin are mixed in 100 mass units of the mixed saturated fatty acid;
after being cooled, the mixture is again heated to 40 through 55° C. and maintained at the temperature; and
a mixed alkaline solution where potassium hydroxide and/or potassium carbonate and sodium hydroxide and/or sodium carbonate are mixed together in a range of the mol ratio of 70/30 to 30/70 is added at once to the mixture that has been heated and maintained at the temperature, the mixture is stirred while the temperature rises to 80 to 95° C. and is maintained at the temperature for neutralization so as to prepare a paste soap composition, and before or after the neutralization, talc and sorbitol are mixed in the paste soap composition in such a manner that 3 to 13 mass units of talc and 50 to 180 mass units of sorbitol relative to 100 mass units of the mixed saturated fatty acid are included in the paste soap composition.

In the case where a large amount of sodium soap is included in the prior art, a paste soap composition having excellent paste maintaining properties over a long period of time at a low temperature cannot be gained; however, the above-described configuration according to the present invention makes it possible for the gained paste soap composition to have long-term paste state maintaining properties in a low temperature range, which thus maintain a stable paste state that does not separate over a long period of time, even in the case where sodium soap is included in a larger amount than in the prior art.

In the production method according to the second aspect of the present invention, in the same manner as in the production method according to the first aspect of the present invention, a chemically synthesized surfactant or a viscosity-inducing agent is not mixed.

The fatty acid that is used in the production method for a paste soap composition according to the present invention is a mixed saturated fatty acid made of saturated fatty acids of which the carbon numbers are 12 to 18, which includes 80 to 90 mol % of saturated fatty acids of which the carbon numbers are 12 and 14. Here, a saturated fatty acid of which the carbon number is 8 or 10 is not included. This is because the stability of the long-term paste state maintaining performance of the paste soap composition is lost at a low temperature in the case where a saturated fatty acid of which the carbon number is 8 or 10 is included.

In the present invention, unsaturated fatty acids are not used. This is because soaps that include an unsaturated fatty acid generate a hue and an odor as a result of oxidization, and thus are not appropriate for cleansing the skin.

As the mixed fatty acid made of saturated fatty acids of which the carbon numbers are 12 to 18, preferably the carbon numbers are 12 to 16, that are used in the production method according to the present invention, a mixed fatty acid made of lauric acid, myristic acid, palmitic acid, and stearic acid, and in particular, a mixture of a plurality of fatty acids including lauric acid and myristic acid, is used.

It is desirable for the mixed fatty acid to be made of a plurality of saturated fatty acids from the point of view of stability over time in terms of the low degrees of a foul odor and a change in the hue.

Furthermore, the entirety of the mixed fatty acid made of these saturated fatty acids includes 80 to 90 mol %, preferably 82 to 88 mol %, of saturated fatty acids of which the carbon number is 12 and 14.

The entirety of the mixed fatty acid always includes saturated fatty acids of which the carbon number is 12 and 14, for example, lauric acid and myristic acid, in the above-described high content, and therefore, it becomes possible for the soap composition to have excellent foaming properties and to maintain the paste state over a long period of time in a low temperature range.

It is also desirable for the amount of the included saturated fatty acid of which the carbon number is 14 to be greater than that of the included saturated fatty acid of which the carbon number is 12, and this is because the above-described effects of the paste soap composition can be exhibited more effectively.

In addition, magnesium stearate or magnesium palmitate is mixed in the above-described mixed fatty acid. It is desirable for this magnesium stearate or magnesium palmitate to be mixed in the mixed saturated fatty acid in advance, and the mixture ratio thereof is 3 to 23 mass units, preferable 8 to 16 mass units, relative to 100 mass units of the mixed saturated fatty acid.

In the case where magnesium stearate or magnesium palmitate is less than 3 mass units relative to 100 mass units of the mixed saturated fatty acid, the fluidity of the paste soap composition may become great. Meanwhile, in the case where magnesium stearate or magnesium palmitate exceeds 23 mass units, the fluidity of the paste composition decreases; however, the texture of the paste becomes coarse, which is not desirable.

In the case where magnesium stearate or magnesium palmitate is mixed, the gained paste soap composition can maintain a paste state over a long period of time, even at a low temperature, providing such effects that the hardening can be suppressed at a low temperature, foaming with lubrication that cannot easily be rinsed off can be provided at the time of cleansing, and at the same time, a good, moist feeling can be provided after cleansing.

Here, the paste soap composition that has been prepared in accordance with the method according to the present invention does not include calcium stearate or calcium palmitate, and thus, calcium stearate or calcium palmitate cannot be used as a substitute for magnesium stearate or magnesium palmitate. This is because calcium stearate or calcium palmitate makes it difficult for the paste soap composition to maintain the paste state maintaining performance over a long period of time in a low temperature range.

Next, the mixture where the above-described mixed saturated fatty acid and magnesium stearate or magnesium palmitate are mixed is heated to a temperature of 80° C. or higher, preferably 90° C. or higher, more preferably 80 to 95° C. (heated temperature), while being stirred so that the mixed saturated fatty acid is uniformly melted. Preferably, the mixture is melted while being stirred. Here, the heated temperature means the highest heated temperature when the heated mixed saturated fatty acid is uniformly melted. As long as the above-described saturated fatty acid can be uniformly melted, the time during which the heated temperature is maintained is not particularly limited; however, the temperature is maintained for 20 to 60 minutes, for example.

It is also preferable for talc to be mixed in the ratio of 3 to 13 mass units, more preferably in the ratio of 5 to 10 mass units, relative to 100 mass units of the mixed saturated fatty acid.

When talc is mixed in such a content ratio, the paste state maintaining performance of the paste soap composition can be more effectively exhibited, even in a low temperature range, and thus, the effects of suppressing the hardening can be gained, which is desirable.

Talc may be mixed when the above-described mixed fatty acid is prepared in advance, may be mixed into the mixed fatty acid together with magnesium stearate, or may be added and mixed after the below-described neutralization treatment.

It is also desirable for a saccharide to be mixed in a ratio of 2 to 12 mass units, preferably 2 to 8 mass units, relative to 100 mass units of the mixed saturated fatty acid.

As a saccharide, a sugar that is available in the market, such as granulated sugar, can be cited as an example. When a saccharide is included, the paste state maintaining performance of the paste soap composition can be more effectively exhibited, even in a low temperature range, and thus, the effects of suppressing hardening can be gained, which is desirable.

A saccharide may be mixed when the above-described mixed fatty acid is prepared in advance, may be mixed into the mixed fatty acid together with magnesium stearate, or may be added and mixed after the below-described neutralization treatment. It is more desirable for a saccharide to be added and mixed after the below-described neutralization treatment.

Next, the above-described heated and melted mixed fatty acid, magnesium stearate or magnesium palmitate, and a saccharide or talc that have been added if necessary are mixed, and a coolant is added at once while the above mixture is being stirred so that the temperature is lowered to a temperature that is lower than the above-described heated temperature by at least 20° C., preferably by 25° C. or greater (cooled temperature). The mixture is cooled to 60° C. or lower, preferably 50° C. or lower.

The mixture of the coolant and the mixed saturated fatty acid that has been cooled by adding the coolant exhibits a state where small white particles have been suspended.

The amount of coolant that is added and mixed may be such that the heated temperature of the liquid mixed fatty acid that has been heated to 80° C. or higher, preferably 90° C. or higher, so as to be melted can be lowered to a temperature that is 70° C. or lower, preferably 60° C. or lower, and that is at least 20° C., preferably 25° C. or greater, lower than the heated temperature when the coolant is added at once. A coolant at room temperature, for example, at approximately 20° C., can be used as a mixture.

The coolant includes glycerin and purified water.

Glycerin in the coolant is preferably 30 to 75 mass units, more preferably 45 to 65 mass units, relative to 100 mass units of the mixed fatty acid. Purified water is preferably 90 to 250 mass units, more preferably 90 to 150 mass units. The coolant that is a mixture of glycerin and purified water in such a ratio, for example, can be added so that the mixture can be cooled from the above-described heated temperature to the cooled temperature that is lower by at least 20° C.

In addition, sorbitol is mixed into the paste soap composition according to the present invention. Sorbitol may be mixed in the coolant in advance or may be partially mixed after the neutralization. The amount of mixed sorbitol is 50 to 200 mass units, preferably 50 to 150 mass units, relative to 100 mass units of the mixed fatty acid. When sorbitol is included, the paste state maintaining performance of the paste soap composition can be more effectively exhibited, even in a low temperature range, and the effects of suppressing hardening can be gained, which is desirable.

Next, the mixed saturated fatty acid containing liquid at the above-described cooled temperature is again heated and maintained at a heat-controlled temperature of 40 to 55° C. When such a process is provided, the gained paste soap composition can maintain the stability (paste state maintaining performance) over a long period of time at a low temperature.

Next, a mixed alkali is added at once to the mixed fatty acid containing liquid (mixture) that has been maintained at the heat-controlled temperature. The mixture is stirred while the temperature rises to 80 to 95° C. at which the temperature is maintained for neutralization, and thus, a paste soap composition is prepared. As described above, alkali is added to the mixed fatty acid containing liquid that is maintained at the heat-controlled temperature after the liquid was quickly cooled and heated again, and then, the liquid is stirred for neutralization where the raised temperature is 80 to 95° C. As a result, it becomes possible for the gained paste soap composition to have paste maintaining performance over a long period of time, even at a low temperature.

Alkali that is used to gain the fatty acid soap by neutralizing the above-described cooled mixed saturated fatty acid is a mixed alkali of potassium hydroxide and/or potassium carbonate and sodium hydroxide and/or sodium carbonate where the mol ratio of the mixture of potassium hydroxide and/or potassium carbonate to sodium hydroxide and/or sodium carbonate is 70/30 to 30/70, preferably 60/40 to 50/50.

Furthermore, it is desirable for purified water to be mixed in the mixed alkali in order to suppress the increase in the viscosity at the time of neutralization reaction or suppress the local generation of heat from neutralization.

As for the mixture of alkali, potassium hydroxide and/or potassium carbonate and sodium hydroxide and/or sodium carbonate may be mixed in advance so that mixed alkali is prepared, which is then used for neutralization, or they may not be mixed in advance, and instead may be respectively mixed in at the time of neutralization, and thus, either case may be possible.

In the case where the mol ratio of potassium hydroxide and/or potassium carbonate is higher than 70, the effects of potassium soap become strong, and the foaming or cleansing power is not satisfactory. Meanwhile, in the case where the ratio of potassium hydroxide is lower than 30, the hardness of the gained soap is too high for the soap to be in a liquid state, and thus, the soap does not dissolve quickly in water at the time of use, which may lower the foaming properties.

It is also possible to prepare an alkali solution in advance (the standard is an active component concentration of 48%, for example) from the two above-described alkalis so that this solution can be used for neutralization of the mixed fatty acid, and as a result, it becomes possible to acquire a uniform solution in a short period of time.

In addition, heat is generated at the time of neutralization; however, in some cases, an increase in the temperature beyond the above-described raised temperature may prevent the gained paste soap composition from acquiring the above-described effects, and therefore, an increase in the temperature may be controlled so that the temperature becomes 80 to 90° C.

As examples of the fatty acid soap that has been gained by saponifying the above-described mixed fatty acid and mixed alkali, a mixed salt of potassium/sodium laureate, a mixed salt of potassium/sodium myristate, a mixed salt of potassium/sodium palmitate, and a mixed salt of potassium/sodium stearate can be cited, and a mixed salt of potassium/sodium laureate and a mixed salt of potassium/sodium myristate should always be included, and at the same time, it is desirable for two or more of the above-described mixed salts to be mixed for use from the point of view of the manufacture of a paste soap having foaming properties, in particular, excellent foaming power.

It is desirable for the paste soap composition that is gained in accordance with the method according to the present invention to include 8 to 35 mass %, preferably 10 to 35 mass %, more preferably 18 to 28 mass %, of a saturated fatty acid soap content. This is because a paste soap composition that provides a more sufficient foam amount at the time of use and is more uniform in the quality can be gained in the case where the saturated fatty acid soap content is in such a range.

The paste soap composition that has been gained in the production method according to the present invention includes water, which corresponds to the water that has been added, the water included in the respective raw materials, and the water that has been generated through neutralization between fatty acid and alkali, and it is illustrated that the water content is 28 to 65 weight %, preferably 35 to 50 weight %, in the paste soap composition.

It is necessary for the water content to be greater as the weight ratio of potassium hydroxide/sodium hydroxide shifts from 70/30 to 30/70. As the ratio of used sodium hydroxide increases, the concentration of sodium salt of fatty acid that is generated through saponification increases. It is possible for this to be because the solubility of the generated sodium salt of fatty acid in water is small.

In the case where the water content exceeds 65 weight %, for example, satisfactory foaming properties or a sufficient amount of foaming cannot be gained at the time of use, whereas in the case where the water content is less than 28 weight %, sometimes soap can be easily hardened at a low temperature.

The water content can be adjusted in the above-described range in order to gain a desirable paste soap composition where the paste state that is appropriate for use can be maintained even in a low temperature range, the viscosity is in an appropriate range, and the paste is not so fluid as to flow out or is not hardened or solidified.

Here, the soap composition that is gained as a final product in accordance with the production method according to the present invention is in a paste state when the maximum load of viscosity that has been measured under the below-described conditions is in a range from 200 to 3499 g/cm² at 5° C.; however, it is desirable for the paste state to be referred to the one of which the maximum load of viscosity is in a range from 200 to 999 g/cm². Here, the one of which the maximum load is from 100 to 199 g/cm² is assessed as emulsion, and the one of which the maximum load is 99 g/cm² or less is assessed as liquid in the present invention.

Conditions: The viscosity is indicated as the value of the maximum load that is measured when the soap composition sample that has been injected into a 20 ml syringe made of polypropylene (Cosmetics S-Refill container No. 403, sold by Daiso Industries Co., Ltd., where the outlet of the syringe is machined so that the diameter is adjusted to 6.0 mm) at a predetermined temperature (5° C.) is discharged through the syringe outlet as the weight is loaded on top of the plunger of the syringe.

If necessary, other arbitrary components can be mixed in as long as the effects of the present invention are not suppressed in addition to the above-described necessary components. For example, higher alcohols, squalane, various types of fatty acid esters in liquid or solid form, various types of purified natural oils or fats such as olive oil or sesame oil, oil components such as middle-chain fatty acid triglyceride, silicone derivatives such as polyoxy ethylene alkyl-modified dimethyl silicone, natural water-soluble polymers such as pectin or alginic acid, biodegradable chelating agents such as sodium gluconate, various types of natural extracts originated from animals or plants, inorganic salts such as common salt and Glauber's salt for the adjustment of the congealing point or hardness, natural antioxidants such as d-tocopherol, natural pigments, natural aromatics, and the like, can be mixed in in such a range that the effects of the present invention are not lost.

### EXAMPLES

In the following, the present invention is described in further detail in reference to the following examples, comparison examples, and test samples; however, the present invention is not limited to these.

The used raw materials are as follows.

### Raw Materials:

(1) Fatty acids
   Lauric acid (carbon number 12: Mw 200.31): Trade Name: NAA 122 (made by NOF Corporation)
   Myristic acid (carbon number 14: Mw 228.36): Trade Name: NAA 142 (made by NOF Corporation)
   Palmitic acid (carbon number 16: Mw 256.42): Trade Name: NAA 160 (made by NOF Corporation)
   Stearic acid (carbon number 18: Mw 284.44): Trade Name: NAA 180 (made by NOF Corporation)
(2) Alkali
   Sodium hydroxide: 48% sodium hydroxide solution (made by Kanto Chemical Industry Co., Ltd., Sample grade: First class)
   Potassium hydroxide: 48% potassium hydroxide solution (made by Kanto Chemical Industry Co., Ltd., Sample grade: First class)
(3) Polyvalent metal salt of fatty acid
   Magnesium stearate: Trade Name: Daiwax M (made by Dainichi Chemical Industry Co., Ltd.)
(4) Alcohols
   Glycerin (Wako first grade: Made by Wako Pure Chemical Corporation)
   Sorbitol: Trade Name: NEOSORB 70/70, made by Shinko Science Corporation (70% water solution))
(5) Saccharide (Granulated sugar made by Mitsui DM Sugar Holdings Co., Ltd.)
(6) Talc: Trade Name: SWA-A TALC, made by Asada Milling Co., Ltd.
(7) Purified water: Trade Name: Purified Water in accordance with the Japanese Pharmacopoeia, made by Kozakai Pharmaceutical Co., Ltd.)
(8) MCT (Medium chain fatty acid triglyceride, oil content), Trade Name: Nisshin MCT oil HC 100%, made by the Nisshin OilliO Group Ltd.
(9) Squalane, made by Kojo Chemicals Co., Ltd.

### A. Liquid Soap Composition

### Examples 1 through 9 and Comparison Examples 1 through 10

The respective fatty acids from among the above-described fatty acids were mixed in the mixture ratios shown in the following Tables 1 and 2, and the respective mixed fatty acids were prepared.

Next, each of the above-described mixed fatty acids was put into a 1 L flask equipped with a stirrer, a thermometer, and a dropping funnel so as to be heated while being stirred at a heated temperature. Then, the mixed fatty acid was stirred for 20 to 60 minutes so as to be completely melted and become a uniform liquid state at each heated temperature (a) shown in Tables 1 and 2, and this state was maintained. Here, the mixed fatty acid that was melted exhibited transparency.

In Comparison Example 5, the liquid where purified water and glycerin were mixed was mixed in the mixed fatty acid in advance, and this mixture was heated to the temperature shown in Tables 1 and 2 (heated temperature (a)).

Purified water and glycerin were mixed in the ratios shown in Tables 1 and 2 so that respective coolants were prepared.

Each of the above-described liquid mixed fatty acids at each heated temperature was stirred, and the coolant at room temperature, at approximately 20° C., was added at once to this mixed fatty acid so as to be quickly cooled. The mixture of the mixed fatty acid and the coolant within the flask was cooled so that the temperature became each cooled temperature (b) shown in Tables 1 and 2 and was further stirred for approximately 5 minutes so that the mixture became uniform, and thus, liquid suspension that was in a white suspended state was gained. Next, the liquid suspension was heated to the heat-controlled temperature (c) at 40 to 50° C., and thus, maintained in this state.

Here, in Comparison Example 5, the mixture where purified water and glycerin were mixed in the ratio of 172 (mass units/100 mass units of mixed fatty acid) to 21 (mass units/100 mass units of mixed fatty acid) was mixed with the mixed fatty acid in advance, and thus was not used as a coolant. Accordingly, the temperature of the mixture in a state after being stirred for approximately 5 minutes at the heated temperature without the above-described cooling process is shown in the columns of the cooled temperature (b) and the heat-controlled temperature (c) for the purpose of convenience.

Next, a mixed alkali solution that had been prepared in advance by mixing a 48% potassium hydroxide solution and/or a 48% sodium hydroxide solution and (Tables 1 and 2) was put at once into a flask containing the above-described suspension, and the mixture was stirred for neutralization (saponification).

Here, the mixed alkali concentration (%) represents the alkali concentration that is found by dividing (48% KOH (g)+48% NaOH (g))×0.48) by (48% KOH (g)+48% NaOH (g)+diluent water (g)).

After the neutralization, the neutralized liquid (saponified liquid) within the flask was stirred so as to be uniform without foaming while again being heated, and thus, aging was carried out for approximately 30 minutes while the raised temperature (d) shown in Tables 1 and 2 was maintained.

After aging, the gained composition was left at room temperature so as to be cooled, and thus, a soap composition was gained.

All the compositions in the examples were in a transparent liquid state at room temperature (assessment in Table 8). The compositions in Comparison Examples 1 through 4 and 7 were transparent liquid soap compositions at room temperature, whereas the composition in Comparison Example 5 was in a semi-solid state at room temperature, and the compositions in Comparison Examples 6 and 8 through 10 were in a solid state at room temperature.

### Test Examples

### (Test Example 1) Transparency/Liquid Stability at Room Temperature

Immediately after the generation, the respective liquid soap compositions that were gained in Examples 1 through 10 and Comparison Examples 1 through 4 and 7 were put into flat-bottom test tubes F25-100 (Model No.: TEST-F25-100, made by AGC Techno Glass Co., Ltd.) to a height of 75 mm without foaming. The test tubes were tightly plugged and left still in a thermostatic bath at 25° C. or a thermostatic bath at 5° C. In the state where the temperature of the compositions became 25° C., the above-described flat-bottom test tubes were visually inspected from the top and from the side in order to assess the transparency.

The compositions were assessed so as to have transparency and were denoted as “transparent” in the case where no white lumps, no white deposits, no muddiness, or no separated substances were recognized via visual inspection, and in addition, a letter with the Mincho font size of 8 that was placed at the bottom of the test tubes was clearly readable as viewed from the top of the flat-bottom test tubes (vertical direction), and the results are shown in Tables 1 and 2.

TABLE 1

| | | Carbon number C | | | | | Coolant | | | |
|---|---|---|---|---|---|---|---|---|---|---|
| | | C12 | C14 | C16 | C18 | | | Purified | | Cooled |
| | | Mixed fatty acid | | | | | (Glycerin) | water | Heated | temperature |
| | | Name of fatty acid | | | | | Mass units/ | Mass units/ | temperature | (b) |
| | | Lauric | Myristic | Palmitic | Stearic | | 100 mass | 100 mass | (a) | (after being |
| | | acid | acid | acid | acid | C12 + | units of | units of | (mixed fatty | quickly |
| Type of | | Molecular weight | | | | C14 | mixed | mixed | acid) | cooled) |
| example | | 200.31 | 228.36 | 256.42 | 284.44 | Mol % | fatty acid | fatty acid | (° C.) | (° C.) |
| Example 1 | Content | 63.62 | 58.24 | 16.32 | 0.00 | 88.21 | 18 | 145 | 95 | 45 |
| | weight(g) | | | | | | | | | |
| Example 2 | Content | 53.18 | 48.53 | 13.60 | 1.14 | 87.34 | 21 | 172 | 95 | 43 |
| | weight(g) | | | | | | | | | |
| Example 3 | Content | 53.18 | 48.53 | 13.60 | 1.14 | 87.34 | 21 | 172 | 95 | 42 |
| | weight(g) | | | | | | | | | |
| Comparison | Content | 56.56 | 78.22 | 26.73 | 6.91 | 80.03 | 15 | 119 | 95 | 47 |
| Example 1 | weight(g) | | | | | | | | | |
| Comparison | Content | 33.83 | 67.65 | 16.90 | 0.50 | 85.36 | 21 | 63 | 70 | 60 |
| Example 2 | weight(g) | | | | | | | | | |
| Comparison | Contant | 58.01 | 44.11 | 13.73 | 0.00 | 88.15 | 22 | 108 | 95 | 60 |
| Example 3 | weight(g) | | | | | | | | | |
| Comparison | Content | 53.18 | 48.53 | 13.60 | 1.14 | 87.34 | 21 | 172 | 95 | 39 |
| Example 4 | weight(g) | | | | | | | | | |
| Comparison | Content | 53.18 | 55.24 | 16.32 | 0.00 | 87.34 | 0 | 0(*1) | 90 | 90 |
| Example 5 | weight(g) | | | | | | | | | |
| Example 4 | Content | 70.00 | 32.51 | 9.23 | 0.71 | 91.16 | 22 | 178 | 95 | 39 |
| | weight(g) | | | | | | | | | |
| Example 5 | Content | 80.00 | 23.53 | 9.23 | 0.71 | 81.24 | 22 | 176 | 95 | 40 |
| | weight(g) | | | | | | | | | |
| Comparison | Content | 53.18 | 48.53 | 13.60 | 1.14 | 87.34 | 21 | 172 | 95 | 48 |
| Example 6 | weight(g) | | | | | | | | | |

| | | Heat- | | | | | | | |
|---|---|---|---|---|---|---|---|---|---|
| | | controlled | Mixed alkali solution | | | | | Raised | |
| | | temperature | Mol | 48% | 48% | Purified | Alkali | temperature | |
| Type of | | (c) | ratio | KOH | NaOH | water | concentration | (d) | |
| example | | (° C.) | K/Na | (g) | (g) | (g) | (%) | (° C.) | State |
| Example 1 | Content | 50 | 65/35 | 48.40 | 18.58 | 75.00 | 22.84 | 90 | Transparent |
| | weight(g) | | | | | | | | liquid at room |
| Example 2 | Content | 50 | 65/351 | 15.49 | 40.35 | 75.00 | 20.49 | 90 | temperature |
| | weight(g) | | | | | | | | |
| Example 3 | Content | 50 | 50/50 | 31.04 | 22.13 | 75.00 | 19.91 | 90 | |
| | weight(g) | | | | | | | | |
| Comparison | Content | 50 | 65/35 | 56.68 | 21.75 | 75.00 | 24.54 | 90 | |
| Example 1 | weight(g) | | | | | | | | |
| Comparison | Content | 60 | 65/35 | 40.35 | 15.49 | 200.00 | 10.48 | 90 | |
| Example 2 | weight(g) | | | | | | | | |
| Comparison | Contant | 50 | 50/50 | 31.02 | 22.13 | 125.00 | 14.32 | 90 | |
| Example 3 | weight(g) | | | | | | | | |
| Comparison | Content | 50 | 40/60 | 24.83 | 26.56 | 75.00 | 19.52 | 70 | Transparent |
| Example 4 | weight(g) | | | | | | | | liquid at room |
| | | | | | | | | | temperature |
| Comparison | Content | 90 | 30/70 | 18.62 | 30.93 | 75.00 | 22.64 | 90 | Semi-solid at |
| Example 5 | weight(g) | | | | | | | | room temerature |
| Example 4 | Content | 50 | 40/60 | 24.79 | 28.51 | 75.00 | 20.49 | 90 | Transparent |
| | weight(g) | | | | | | | | liquid at room |
| | | | | | | | | | temperature |
| Example 5 | Content | 50 | 30/70 | 25.28 | 27.03 | 75.00 | 19.91 | 90 | Transparent |
| | weight(g) | | | | | | | | liquid at room |
| | | | | | | | | | temperature |
| Comparison | Content | 50 | 20/80 | 12.41 | 35.40 | 75.00 | 24.54 | 90 | Solid at room |
| Example 6 | weight(g) | | | | | | | | temperature |

(*1)In Comparison Example 5, from the beginning 172 mass units of water relative to 100 mass units of fatty acid and 21 mass units of glycerin relative to 100 mass units of fatty acid were mixed together with a fatty acid. which was thus melted via heating and maintained at the heated temperature, and after that, a mixed alkali was mixed in without being cooled.

TABLE 2

| | | Carbon number C | | | | | Coolant | | | |
|---|---|---|---|---|---|---|---|---|---|---|
| | | C12 | C14 | C16 | C18 | | | Purified | | Cooled |
| | | Mixed fatty acid | | | | | (Glycerin) | water | Heated | temperature |
| | | Name of fatty acid | | | | | Mass units/ | Mass units/ | temperature | (b) |
| | | Lauric | Myristic | Palmitic | Stearic | | 100 mass | 100 mass | (a) | (after being |
| | | acid | acid | acid | acid | C12 + | units of | units of | (mixed fatty | quickly |
| Type of | | Molecular weight | | | | C14 | mixed | mixed | acid) | cooled) |
| example | | 200.31 | 228.38 | 258.42 | 284.44 | Mol % | fatty acid | fatty acid | (° C.) | (° C.) |
| Example 6 | Content | 53.18 | 48.53 | 13.60 | 0.00 | 88.21 | 22 | 173 | 95 | 45 |
| | weight(g) | | | | | | | | | |
| Example 7 | Content | 83.82 | 58.24 | 16.32 | 0.00 | 88.21 | 18 | 145 | 95 | 43 |
| | weight(g) | | | | | | | | | |
| Comparison | Content | 63.82 | 58.24 | 16.32 | 0.00 | 88.21 | 18 | 145 | 95 | 42 |
| Example 7 | weight(g) | | | | | | | | | |
| Comparison | Content | 83.82 | 58.24 | 16.32 | 0.00 | 88.21 | 18 | 145 | 95 | 47 |
| Example 8 | weight(g) | | | | | | | | | |
| Comparison | Content | 38.34 | 58.22 | 48.95 | 0.00 | 88.36 | 17 | 137 | 95 | 43 |
| Example 9 | weight(g) | | | | | | | | | |
| Example 8 | Content | 85.60 | 43.30 | 5.20 | 0.00 | 96.12 | 15 | 149 | 95 | 42 |
| | weight(g) | | | | | | | | | |
| Comparison | Content | 65.30 | 30.20 | 32.00 | 1.14 | 74.90 | 19 | 157 | 95 | 39 |
| Example 10 | weight(g) | | | | | | | | | |
| Example 9 | Content | 63.82 | 58.24 | 18.32 | 0.00 | 88.21 | 18 | 288 | 95 | 40 |
| | weight(g) | | | | | | | | | |

| | | Heat- | | | | | | | |
|---|---|---|---|---|---|---|---|---|---|
| | | controlled | Mixed alkali solution | | | | | Raised | |
| | | temperature | Mol | 48% | 48% | Purified | Alkali | temperature | |
| Type of | | (c) | ratio | KOH | NaOH | water | concentration | (d) | |
| example | | (° C.) | K/Na | (g) | (g) | (g) | (%) | (° C.) | State |
| Example 6 | Content | 50 | 70/30 | 43.45 | 13.27 | 75.00 | 20.67 | 90 | Transparent |
| | weight(g) | | | | | | | | liquid at room |
| | | | | | | | | | temperature |
| Example 7 | Content | 50 | 80/20 | 59.51 | 10.52 | 75.00 | 23.19 | 90 | Transparent |
| | weight(g) | | | | | | | | liquid at room |
| | | | | | | | | | temperature |
| Comparison | Content | 50 | 100/0 | 74.49 | 0.00 | 75.00 | 23.92 | 90 | Transparent |
| Example 7 | weight(g) | | | | | | | | liquid at room |
| | | | | | | | | | temperature |
| Comparison | Content | 50 | 0/100 | 0.00 | 53.10 | 75.00 | 19.90 | 90 | Solid at room |
| Example 8 | weight(g) | | | | | | | | temperature |
| Comparison | Content | 50 | 65/35 | 48.42 | 18.58 | 75.00 | 22.05 | 90 | Solid at room |
| Example 9 | weight(g) | | | | | | | | temperature |
| Example 8 | Content | 50 | 65/35 | 48.42 | 18.58 | 75.00 | 22.65 | 90 | Transparent |
| | weight(g) | | | | | | | | liquid at room |
| | | | | | | | | | temperature |
| Comparison | Content | 50 | 65/35 | 44.30 | 17.00 | 75.00 | 21.59 | 90 | Solid at room |
| Example 10 | weight(g) | | | | | | | | temperature |
| Example 9 | Content | 50 | 65/35 | 45.42 | 18.58 | 75.00 | 19.25 | 90 | Transparent |
| | weight(g) | | | | | | | | liquid at room |
| | | | | | | | | | temperature |

### (Preparation of Soapy Water)

5% soapy water and 10% soapy water were prepared from purified water and the soap compositions that were gained in the respective examples and comparison examples, and the following tests were carried out.

### (Test Example 2) Liquid State Maintaining Performance/Transparency

The respective types of soapy water that were gained from the respective soap compositions that were gained from Examples 1 through 9 and Comparison Examples 1 through 10 were put into flat-bottom test tubes F25-100 (Model No.: TEST-F25-100, made by AGC Techno Glass Co., Ltd.) to a height of 75 mm without foaming. The test tubes were tightly plugged and left to sit still in a thermostat bath at 5° C. for one week. The liquid state maintaining performance after being left for one week was assessed through visual inspection, and the transparency was assessed by visually inspecting the flat-bottom test tubes from the top and the sides.

As for the assessment, the stability was determined at 5° C. (after one week) as follows. The results are shown in Table 3.
In the case where a white solid was deposited or solidification was viewed through visual inspection, it was determined that the liquid state maintaining performance was not held with poor transparency (x).
In the case where no white lumps, no white deposits, no muddiness, or no separated substances were recognized as a result of the visual inspection, and in addition, a letter with the Mincho font size of 8 that was placed at the bottom of the test tubes was clearly readable as viewed from the top of the flat-bottom test tubes (vertical direction), the transparency was good, and the liquid state was recognized in accordance with the following standard in Test Example 4 (∘).

### (Test Example 3) Foaming Properties

In accordance with a simple vibration method, a test for the foaming properties at 5° C. was carried out on the compositions where 5% soapy water and 10% soapy water were both transparent liquids from among the compositions in the above-described examples and comparison examples.

Concretely, 3 g of each gained soapy water were weighed and injected into 3 flat-bottom test tubes (TEST-F25-100) with a diameter of 25 mm made by AGC Techno Glass Co., Ltd., by using a pipette. The test tubes were tightly sealed with a vinyl chloride wrap film and a rubber band and were dipped for 30 minutes into a thermostat bath at 5° C. in which a test tube rack was set up, and then were vibrated through 20 semi-rotations within 20 seconds. Immediately after that, a foaming property test was carried out in order to find the height of the foam by measuring the height of the liquid surface from the bottom of the test tube and the height of the highest foaming level.

After that, the respective test tubes were again dipped in the thermostat bath and left to sit still for 5 minutes. After that, a foaming property test was carried out in order to find the height of the foam by measuring the height of the liquid surface and the highest level of the foam. The same operation was carried out for all of the three test tubes so as to find the average value of the liquid surface and the height of the foam through calculation, and thus, the foaming properties of the respective fatty acid soap compositions were determined.

The results are shown in Table 3.

Here, the results of the assessment were as follows.
In the case where the height of the foam that was measured after 5 minutes was 30 mm or greater, the foaming properties were high (∘).
In the case where the height of the foam was less than 20 mm, the foaming properties were low (x).
In the case where the height of the foam was no less than 20 mm and less than 30 mm, the foaming properties were in the middle (Δ).

### Total Assessment (5° C.)

Compositions of which the assessments in Test Examples 2 and 3 were all ∘ were denoted as ∘.
Compositions of which the assessments in Test Examples 2 and 3 included x were denoted as Δ.
Compositions of which the assessments in Test Examples 2 and 3 were all x were denoted as x.

The results are shown in Table 3.

TABLE 3

| | Soapy water(transparency* liquid | | | |
|---|---|---|---|---|
| | state maintaining performance) | | | Total |
| Type of | 10% soapy | 5% soapy | Foaming | assess- |
| Example | water | water | properties | ment |
| Example 1 | ∘ | ∘ | ∘ | ∘ |
| Example 2 | ∘ | ∘ | ∘ | ∘ |
| Example 3 | ∘ | ∘ | ∘ | ∘ |
| Comparison | x | x | — | x |
| Example 1 | | | | |
| Comparison | x | ∘ | — | Δ |
| Example 2 | | | | |
| Comparison | x | ∘ | — | Δ |
| Example 3 | | | | |
| Comparison | x | ∘ | — | Δ |
| Example 4 | | | | |
| Comparison | x | x | — | x |
| Example 5 | | | | |
| Example 4 | ∘ | ∘ | ∘ | ∘ |
| Example 5 | ∘ | ∘ | ∘ | ∘ |
| Comparison | x | x | — | x |
| Example 6 | | | | |
| Example 6 | ∘ | ∘ | ∘ | ∘ |
| Example 7 | ∘ | ∘ | ∘ | ∘ |
| Comparison | ∘ | ∘ | x | x |
| Example 7 | | | | |
| Comparison | x | x | — | x |
| Example 8 | | | | |
| Comparison | x | x | — | x |
| Example 9 | | | | |
| Example 8 | ∘ | ∘ | ∘ | ∘ |
| Comparison | x | ∘ | — | Δ |
| Example 10 | | | | |
| Example 9 | ∘ | ∘ | ∘ | ∘ |

As can be seen from the above Tables 1 through 3, the liquid soap compositions in all the examples were excellent in the liquid state maintaining performance and transparency at a low temperature, and were also excellent in foaming properties.

In addition, the respective liquid soap compositions in the examples as well as 5% solutions and 10% solutions of these liquid soap compositions were preserved for one month in a low temperature state at 5° C. The above-described Test Examples 2 and 3 were carried out on these preserved samples to find that the liquid maintaining performance was maintained and the liquids were transparent with good foaming properties (∘), and thus, the same results as in Table 3 were gained.

### B. Paste Soap Composition

### Examples 10 through 20 and Comparison Examples 11 through 20

The respective fatty acids in the above were mixed in the respective mixture ratios shown in the following Tables 4 and 6 so as to prepare respective mixed fatty acids. Each mixed fatty acid was mixed with magnesium stearate and talc in the mixture ratios shown in following Tables 4 and 6 (mixed fatty acid mixtures).

Next, each of the above-described mixed fatty acid mixtures was put into a 1 L flask equipped with a stirrer, a thermometer, and a dropping funnel. The mixed fatty acid was heated so that the temperature rose while being stirred, and thus was all melted at each heated temperature (a) shown in Tables 5 and 7 while stirring was maintained for 20 to 60 minutes.

Glycerin and sorbitol were mixed into purified water in each ratio shown in Tables 4 and 6 (here, the numeric values of sorbitol in Tables 4 and 6 are not mass units of a sorbitol solution, but represent the substantial mass units of sorbitol) so as to prepare each coolant.

The mixed fatty acid mixture at each of the above-described heated temperatures was being stirred when a coolant at approximately 20° C. was added once to the mixed fatty acid mixture, which was thus quickly cooled. The temperature of the mixture of the mixed fatty acid mixture and the coolant within the flask was each cooled temperature (b) shown in Tables 5 and 7, and the mixture was kept being stirred for approximately five minutes so as to have a uniform quality, and thus, a suspension in a white suspended state was gained. Next, the suspension was heated to the heat-controlled temperature (c) shown in Tables 5 and 7, and this state was maintained.

Next, a mixed alkali solution that had been prepared in advance by mixing 48% potassium hydroxide solution and/or 48% sodium hydroxide solution and (Tables 5 and 7) was put at once into the flask containing each of the above-described suspensions at the heat-controlled temperature, and the mixture kept being stirred for neutralization (saponification).

Here, the mixed alkali concentration (%) represents the alkali concentration that is found by dividing (48% KOH (g)+48% NaOH (g))×0.48) by (48% KOH (g)+48% NaOH (g)+diluent water (g)).

After neutralization, granulated sugar, MCT, and squalane were mixed in if necessary, in the ratios shown in Tables 4 through 7. Next, the neutralized liquid (saponified liquid) within the flask was heated while being stirred so as to be uniform without foaming. The raised temperature (d) shown in Tables 5 and 7 was maintained for approximately 30 minutes for aging.

After aging, the gained composition was left at room temperature so as to be cooled, and thus, a soap composition was gained.

In all of the examples, a fatty acid soap composition in paste form was gained.

### (Test Example 4) Paste State Maintaining Performance

Each soap composition gained in Examples 10 through 20, Comparison Examples 11, 12, 14 through 16, and 18 through 20 was put into a flat-bottom test tube F25-100 (Model No.: TEST-F25-100, made by AGC Techno Glass Co., Ltd.) to a height of 75 mm without foaming. The test tube was tightly plugged and left to sit still in a thermostat bath at 5° C. for one month. After being left to sit still for one month, the paste maintaining performance was assessed through visual inspection, and was assessed in the following viscosity test. Here, the soap compositions in Comparison Examples 13 and 17 were solidified even at room temperature, and were in a solid state after being left to sit still at 5° C. for one month.

The following viscosity test was carried out on each soap composition that had been left to sit still at 5° C. for one month to see if it was still in paste form at 5° C.

### (Viscosity Test)

A 20 ml syringe made of polypropylene (Cosmetics S-Refill Container No. 403, sold by Daiso Industries Co., Ltd.), of which the outlet was cut and processed so as to be a hole with an inner diameter of 6.0 mm, was prepared (the diameter of the syringe outlet was 6.00 mm). Approximately 15 ml of each soap composition that was kept at a predetermined temperature (5° C.) was injected into the above-described syringe, and the outlet was clogged without air being mixed in and the content was compressed. After that, it was confirmed that each sample was put out in columnar form, which was then fixed vertically on a base.

Next, weight was loaded in a plastic box (13 g) installed on top of the plunger of the syringe so that the maximum load when each soap composition sample started being discharged from within the syringe was measured as the viscosity test. It was assessed in respect to the assessment standard shown in the following Table 8. The gained results are shown in the following Table 9.

### (Test Example 5) Foaming Properties

In accordance with a simple vibration method, a test for the foaming properties at 5° C. was carried out on the samples that had maintained the paste state maintaining performance in Test Example 4.

Concretely, 3 g of each gained soap in paste form and 5 ml of purified water were weighed and injected into 3 flat-bottom test tubes (TEST-F25-100) with a diameter of 25 mm made by AGC Techno Glass Co., Ltd., by using a pipette. The test tubes were tightly sealed with a vinyl chloride wrap film and a rubber band and were dipped for 30 minutes into a thermostat bath at 5° C. in which a test tube rack was set up, and then were vibrated through 20 semi-rotations within 20 seconds. Immediately after that, a foaming property test was carried out in order to find the height of the foam by measuring the height of the liquid surface from the bottom of the test tube and the height of the highest foaming level.

After that, the respective test tubes were again dipped in the thermostat bath and left to sit still for 5 minutes. After that, a foaming property test was carried out in order to find the height of the foam by measuring the height of the liquid surface and the highest level of the foam. The same operation was carried out for all of the three test tubes so as to find the average value of the liquid surface and the height of the foam through calculation, and thus, the foaming properties of the respective fatty acid soap compositions were determined.

Here, the results of the assessment were as follows.
In the case where the height of the foam that was measured after 5 minutes was 30 mm or greater, the foaming properties were high (∘).
In the case where the height of the foam was less than 20 mm, the foaming properties were low (x).
In the case where the height of the foam was no less than 20 mm and less than 30 mm, the foaming properties were in the middle (Δ).

The gained results are shown in the following Table 9.

TABLE 4

| | | Carbon number C | | | | | | |
|---|---|---|---|---|---|---|---|---|
| | | C12 | C14 | C16 | C18 | | | |
| | | Mixed fatty acid | | | | | Mg stearate | Talc |
| | | Name of fatty acid | | | | | Mass units/ | Mass units/ |
| | | Lauric | Myristic | Palmitic | Stearic | | 100 mass | 100 mass |
| | | acid | acid | acid | acid | C12 + | units of | units of |
| | | Molecular weight | | | | C14 | mixed fatty | mixed fatty |
| Type of example | | 200.31 | 228.36 | 256.42 | 284.44 | Mol % | acid | acid |
| Example 10 | Content weight(g) | 36.34 | 72.70 | 18.16 | 3.63 | 83.34 | 11.5 | 6.11 |
| Example 11 | Content weight(g) | 36.34 | 72.70 | 18.16 | 3.63 | 83.34 | 11.5 | 6.11 |
| Example 12 | Content weight(g) | 37.07 | 74.15 | 18.52 | 3.70 | 83.35 | 11.2 | 6.00 |
| Example 13 | Content weight(g) | 37.07 | 74.15 | 18.52 | 3.70 | 83.35 | 11.2 | 6.00 |
| Example 14 | Content weight(g) | 36.34 | 72.70 | 18.16 | 3.63 | 83.34 | 11.5 | 6.11 |
| Comparison Example 11 | Content weight(g) | 36.34 | 72.70 | 18.16 | 3.63 | 83.34 | 11.5 | 6.11 |
| Comparison Example 12 | Content weight(g) | 36.34 | 72.70 | 18.16 | 3.63 | 83.34 | 11.5 | 6.11 |
| Comparison Example 13 | Content weight(g) | 36.34 | 72.70 | 18.16 | 3.63 | 83.34 | 11.5 | 15.67 |
| Comparison Example 14 | Content weight(g) | 36.34 | 72.70 | 18.16 | 3.63 | 83.34 | 11.5 | 6.11 |
| Comparison Example 15 | Content weight(g) | 36.34 | 72.70 | 18.16 | 3.63 | 83.34 | 11.5 | 6.11 |
| Comparison Example 16 | Content weight(g) | 36.34 | 72.70 | 18.16 | 3.63 | 83.34 | 0.0 | 6.11 |
| Comparison Example 17 | Content weight(g) | 36.34 | 72.70 | 18.16 | 3.63 | 83.34 | 25.3 | 6.11 |
| Comparison Example 18 | Content weight(g) | 36.34 | 72.70 | 18.16 | 3.63 | 83.34 | 11.5 | 1.57 |

| | | | Coolant | | | |
|---|---|---|---|---|---|---|
| | | Granulated | | Purified | | |
| | | sugar | (Glycerin) | water | Sorbitol | MCT |
| | | Mass units/ | Mass units/ | Mass units/ | Mass units/ | Mass units/ |
| | | 100 mass | 100 mass | 100 mass | 100 mass | 100 mass |
| | | units of | units of | units of | units of | units of |
| | | mixed fatty | mixed fatty | mixed fatty | mixed fatty | mixed fatty |
| Type of example | | acid | acid | acid | acid | acid |
| Example 10 | Content weight(g) | 5.35 | 54 | 121 | 120 | 4.04 |
| Example 11 | Content weight(g) | 5.35 | 54 | 121 | 134 | 4.04 |
| Example 12 | Content weight(g) | 5.25 | 52 | 118 | 112 | 3.96 |
| Example 13 | Content weight(g) | 2.25 | 52 | 106 | 94 | 3.96 |
| Example 14 | Content weight(g) | 5.35 | 61 | 121 | 144 | 4.04 |
| Comparison Example 11 | Content weight(g) | 5.35 | 19 | 121 | 134 | 4.04 |
| Comparison Example 12 | Content weight(g) | 5.35 | 92 | 121 | 134 | 4.04 |
| Comparison Example 13 | Content weight(g) | 5.35 | 54 | 121 | 134 | 4.04 |
| Comparison Example 14 | Content weight(g) | 5.35 | 54 | 121 | 37 | 4.04 |
| Comparison Example 15 | Content weight(g) | 5.35 | 54 | 121 | 214 | 4.04 |
| Comparison Example 16 | Content weight(g) | 5.35 | 54 | 121 | 134 | 4.04 |
| Comparison Example 17 | Content weight(g) | 5.35 | 54 | 121 | 134 | 4.04 |
| Comparison Example 18 | Content weight(g) | 5.35 | 54 | 121 | 134 | 4.04 |

TABLE 5

| | | Cooled | | | | | | | | |
|---|---|---|---|---|---|---|---|---|---|---|
| | Heated | temperature | | | | | | | | |
| | temperature | (b) | Heat- | | | | | | | |
| | (a) | (after being | controlled | Mixed alkali solution | | | | | Raised | |
| | (mixed fatty | quickly | temperature | Mol | 48% | 48% | Purified | Alkali | temperature | |
| Type of | acid) | cooled) | (c) | ratio | KOH | NaOH | water | concentration | (d) | |
| example | (° C.) | (° C.) | (° C.) | K/Na | (g) | (g) | (g) | (%) | (° C.) | State |
| Example 10 | 90 | 43 | 50 | 50/50 | 31.00 | 22.09 | 113 | 15.3 | 90 | White paste at |
| Example 11 | 90 | 44 | 50 | 50/50 | 31.00 | 22.09 | 113 | 15.3 | 90 | room temperature |
| Example 12 | 90 | 45 | 50 | 50/50 | 31.00 | 22.09 | 113 | 15.3 | 90 | |
| Example 13 | 90 | 42 | 50 | 65/35 | 40.69 | 15.62 | 113 | 16.0 | 90 | |
| Example 14 | 90 | 46 | 50 | 35/65 | 21.48 | 28.44 | 113 | 14.7 | 90 | |
| Comparison | 90 | 41 | 50 | 50/50 | 31.00 | 22.09 | 113 | 15.3 | 90 | White paste at |
| Example 11 | | | | | | | | | | room temperature |
| Comparison | 90 | 48 | 50 | 50/50 | 31.00 | 22.09 | 113 | 15.3 | 90 | White emulsion |
| Example 12 | | | | | | | | | | |
| Comparison | 90 | 45 | 50 | 50/50 | 31.00 | 22.09 | 113 | 15.3 | 90 | White solid at |
| Example 13 | | | | | | | | | | room temperature |
| Comparison | 90 | 43 | 50 | 50/50 | 31.00 | 22.09 | 113 | 15.3 | 90 | White paste at |
| Example 14 | | | | | | | | | | room temperature |
| Comparison | 90 | 42 | 50 | 50/50 | 31.00 | 22.09 | 113 | 15.3 | 90 | White emulsion |
| Example 15 | | | | | | | | | | |
| Comparison | 90 | 85 | 90 | 50/50 | 31.00 | 22.09 | 113 | 15.3 | 90 | White paste at |
| Example 16 | | | | | | | | | | room temperature |
| Comparison | 90 | 44 | 50 | 50/50 | 31.00 | 22.09 | 113 | 15.3 | 90 | White solid at |
| Example 17 | | | | | | | | | | room temperature |
| Comparison | 90 | 40 | 50 | 50/50 | 31.00 | 22.09 | 113 | 15.3 | 90 | Translucent |
| Example 18 | | | | | | | | | | emulsion |

TABLE 6

| | | Carbon number C | | | | | | | |
|---|---|---|---|---|---|---|---|---|---|
| | | C12 | C14 | C16 | C18 | | | | Granulated |
| | | Mixed fatty acid | | | | | Mg stearate | Talc | sugar |
| | | Name of fatty acid | | | | | Mass units/ | Mass units/ | Mass units/ |
| | | Lauric | Myristic | Palmitic | Stearic | | 100 mass | 100 mass | 100 mass |
| | | acid | acid | acid | acid | C12 + | units of | units of | units of |
| Type of | | Molecular weight | | | | C14 | mixed fatty | mixed fatty | mixed fatty |
| example | | 200.31 | 228.36 | 256.42 | 284.44 | Mol % | acid | acid | acid |
| Example 15 | Content | 36.34 | 72.70 | 18.16 | 3.63 | 83.34 | 15.3 | 7.64 | 5.35 |
| | weight(g) | | | | | | | | |
| Example 16 | Content | 37.07 | 74.15 | 18.52 | 3.70 | 83.35 | 15.0 | 7.49 | 5.25 |
| | weight(g) | | | | | | | | |
| Example 17 | Content | 36.34 | 72.70 | 18.16 | 3.63 | 83.34 | 15.3 | 7.64 | 5.35 |
| | weight(g) | | | | | | | | |
| Example 18 | Content | 36.34 | 72.70 | 18.16 | 3.63 | 83.34 | 15.3 | 7.64 | 5.35 |
| | weight(g) | | | | | | | | |
| Example 19 | Content | 211.94 | 422.42 | 105.47 | 21.02 | 83.38 | 8.1 | 7.00 | 3.89 |
| | weight(g) | | | | | | | | |
| Example 20 | Content | 36.34 | 72.43 | 18.08 | 3.60 | 83.38 | 8.1 | 7.00 | 3.89 |
| | weight(g) | | | | | | | | |
| Comparison | Content | 34.50 | 67.62 | 27.94 | 3.64 | 76.38 | 15.0 | 7.48 | 5.24 |
| Example 19 | weight(g) | | | | | | | | |
| Comparison | Content | 38.30 | 80.10 | 10.30 | 0.00 | 92.00 | 15.5 | 7.77 | 5.44 |
| Example 20 | weight(g) | | | | | | | | |

| | | Coolant | | | | |
|---|---|---|---|---|---|---|
| | | | Purified | | | |
| | | (Glycerin) | water | Sorbitol | MCT | |
| | | Mass units/ | Mass units/ | Mass units/ | Mass units/ | |
| | | 100 mass | 100 mass | 100 mass | 100 mass | |
| | | units of | units of | units of | units of | |
| Type of | | mixed fatty | mixed fatty | mixed fatty | mixed fatty | Squalane |
| example | | acid | acid | acid | acid | (g) |
| Example 15 | Content | 48 | 132 | 54 | 4.04 | 0.00 |
| | weight(g) | | | | | |
| Example 16 | Content | 45 | 130 | 52 | 3.96 | 0.00 |
| | weight(g) | | | | | |
| Example 17 | Content | 46 | 132 | 75 | 4.04 | 0.00 |
| | weight(g) | | | | | |
| Example 18 | Content | 46 | 128 | 70 | 4.04 | 0.00 |
| | weight(g) | | | | | |
| Example 19 | Content | 47 | 90 | 98 | 4.64 | 0.91 |
| | weight(g) | | | | | |
| Example 20 | Content | 47 | 90 | 98 | 4.64 | 0.16 |
| | weight(g) | | | | | |
| Comparison | Content | 45 | 125 | 68 | 3.95 | 0.00 |
| Example 19 | weight(g) | | | | | |
| Comparison | Content | 47 | 134 | 71 | 4.10 | 0.00 |
| Example 20 | weight(g) | | | | | |

TABLE 7

| | | Cooled | | | | | | | | |
|---|---|---|---|---|---|---|---|---|---|---|
| | Heated | temperature | | | | | | | | |
| | temperature | (b) | Heat- | | | | | | | |
| | (a) | (after being | controlled | Mixed alkali solution | | | | | Raised | |
| | (mixed fatty | quickly | temperature | Mol | 48% | 48% | Purified | Alkali | temperature | |
| Type of | acid) | cooled) | (c) | ratio | KOH | NaOH | water | concentration | (d) | |
| example | (° C.) | (° C.) | (° C.) | K/Na | (g) | (g) | (g) | (%) | (° C.) | State |
| Example 15 | 95 | 45 | 50 | 50/50 | 31.04 | 22.13 | 113.00 | 15.4 | 85 | Paste at room |
| Example 16 | 95 | 44 | 50 | 50/50 | 31.04 | 22.13 | 113.00 | 15.4 | 85 | temperature |
| Example 17 | 95 | 44 | 50 | 50/50 | 31.04 | 22.13 | 113.00 | 15.4 | 85 | |
| Example 18 | 95 | 46 | 50 | 50/50 | 31.04 | 22.13 | 107.50 | 15.9 | 85 | |
| Example 19 | 90 | 42 | 50 | 65/35 | 231.96 | 89.09 | 514.15 | 18.5 | 85 | |
| Example 20 | 95 | 50 | 50 | 65/35 | 39.77 | 15.28 | 88.16 | 18.5 | 85 | |
| Comparison | 95 | 48 | 50 | 50/50 | 31.04 | 22.13 | 107.50 | 15.9 | 85 | Paste at room |
| Example 19 | | | | | | | | | | temperature |
| Comparison | 95 | 44 | 50 | 65/35 | 39.81 | 15.28 | 113.00 | 15.7 | 85 | Liquid at room |
| Example 20 | | | | | | | | | | temperature |

TABLE 8

| | Maximum load | |
|---|---|---|
| Assessment standard | (g/cm²) | Assessment |
| Hard(Solid) | More than 8,800 | X |
| Slightly hard | 3,500 through 8,800 | Δ |
| Soft(Paste) | 1,000 through 3,499 | ◯ |
| Very soft but without | 200 through 999 | ⊚ |
| fluidity(Paste) | | |
| Having slight fluidity(Emulsion) | 100 through 199 | ⋄ |
| Having fludity(Liquid) | 99 or less | □ |

TABLE 9

| Type of | Paste state maitaining | Foaming |
|---|---|---|
| example | performance | properties |
| Example 10 | ∘ for one month | ∘ |
| Example 11 | ∘ for one month | ∘ |
| Example 12 | ∘ for one month | ∘ |
| Example 13 | ∘ for one month | ∘ |
| Example 14 | ∘ for one month | ∘ |
| Comparison | Solid after one week | — |
| Example 11 | | |
| Comparison | Liquid | — |
| Example 12 | | |
| Comparison | Solid | — |
| Example 13 | | |
| Comparison | Solid after one week | — |
| Example 14 | | |
| Comparison | Liquid | — |
| Example 15 | | |
| Comparison | Solid after one month | — |
| Example 16 | | |
| Comparison | Solid | — |
| Example 17 | | |
| Comparison | Liquid | — |
| Example 18 | | |
| Example 15 | ∘ for one month | ∘ |
| Example 16 | ∘ for one month | ∘ |
| Example 17 | ∘ for one month | ∘ |
| Example 18 | ∘ for one month | ∘ |
| Example 19 | ∘ for one month | ∘ |
| Example 20 | ∘ for one month | ∘ |
| Comparison | Solid after one week | — |
| Example 19 | | |
| Comparison | x i.e. failed to become paste | — |
| Example 20 | | |

As can be seen from the above Table 9, all the paste soap compositions in the examples were excellent in the paste maintaining performance at a low temperature, and were also excellent in the foaming properties. Meanwhile, it can be seen that the gained soap where any of the respective components has a mixture amount out of the range in the present invention was inferior in the long-term paste maintaining performance at 5° C., could not maintain the paste state, and thus flowed out or was solidified.

### INDUSTRIAL APPLICABILITY

The liquid soap composition or the paste soap composition that is prepared in accordance with the production method for a soap composition containing sodium of a higher fatty acid and potassium of a higher fatty acid according to the present invention can maintain a liquid or paste state even in a cold district or even in winter season, and therefore is easy to use and can be effectively applied for cleansing the face and/or the body.

1. A production method for a soap composition containing sodium of a higher fatty acid and potassium of a higher fatty acid, according to which a liquid soap composition is prepared by heating to 80° C. or higher and melting a mixed saturated fatty acid, which is a mixed fatty acid made of saturated fatty acids of which the carbon numbers are 12 to 18 that include 85 through 100 mol % of saturated fatty acids of which the carbon numbers are 12 and 14, and does not include saturated fatty acids of which the carbon numbers are 8 through 10, and then cooling the mixed saturated fatty acid to a temperature that is lower than the heated temperature by at least 20° C. by adding at once a coolant made of glycerin and water, and after that, again heating the mixed saturated fatty acid to 40 through 55° C., maintaining the mixed saturated fatty acid at the temperature, adding at once a mixed alkaline solution where potassium hydroxide and/or potassium carbonate and sodium hydroxide and/or sodium carbonate are mixed together in a range of the mol ratio of 90/10 through 30/70 to the mixed fatty acid containing liquid that is maintained at the temperature, stirring the liquid so that the temperature rises to 80 to 95° C., and maintaining the liquid at the temperature for neutralization.

2. The production method for a soap composition containing sodium of a higher fatty acid and potassium of a higher fatty acid according to claim 1, characterized in that the amount of the contained saturated fatty acid of which the carbon number is 12 is greater than that of the contained saturated fatty acid of which the carbon number is 14.

3. A production method for a soap composition containing sodium of a higher fatty acid and potassium of a higher fatty acid, according to which:
a mixture of 100 mass units of a mixed saturated fatty acid and 3 to 23 mass units of magnesium stearate or magnesium palmitate is heated to 80° C. or higher so that the mixed saturated fatty acid melts, where the mixed saturated fatty acid is a mixed fatty acid made of saturated fatty acids of which the carbon numbers are 12 through 18, which include 80 to 90 mol % of saturated fatty acids of which the carbon numbers are 12 and 14 and that do not include a saturated fatty acid of which the carbon number is any of 8 through 10;
a coolant made of glycerin and water is then added at once to the mixture of the mixed saturated fatty acid and magnesium stearate or magnesium palmitate so that the mixture is cooled to a temperature that is lower than the heated temperature by at least 20° C., where 30 to 75 mass units of glycerin are mixed in 100 mass units of the mixed saturated fatty acid;
after being cooled, the mixture is again heated to 40 through 55° C. and maintained at the temperature; and
a mixed alkaline solution where potassium hydroxide and/or potassium carbonate and sodium hydroxide and/or sodium carbonate are mixed together in a range of the mol ratio of 70/30 to 30/70 is added at once to the mixture that has been heated and maintained at the temperature, the mixture is stirred while the temperature rises to 80 to 95° C. and is maintained at the temperature for neutralization so as to prepare a paste soap composition, and before or after the neutralization, talc and sorbitol are mixed in the paste soap composition in such a manner that 3 to 13 mass units of talc and 50 to 180 mass units of sorbitol relative to 100 mass units of the mixed saturated fatty acid are included in the paste soap composition.

4. The production method for a soap composition containing sodium of a higher fatty acid and potassium of a higher fatty acid according to claim 3, characterized by further comprising mixing of a saccharide and/or a fat or an oil.
